(19) United States
(12) Patent Application Publication
(10) Pub. No.: US 2006/0008611 A1
(43) Pub. Date: Jan. 12, 2006

(54) Sealing of honeycomb core and the honeycomb core assembly made with the same

(76) Inventors: Shyan Bob Shen, Taichung (TW); Biing-Shann Yu, Taichung (TW); Han-Chi Liu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/227,257

(22) Filed: Sep. 16, 2005

Related U.S. Application Data
(62) Division of application No. 10/728,868, filed on Dec. 8, 2003.

(51) Int. Cl. B32B 3/16

(52) U.S. Cl. 428/73; 428/116

(57) ABSTRACT

The invention provides a new sealing process for the RTM of honeycomb structures. A thermoplastic polyurethane film is first heated and adhered on the surface of honeycomb core to seal the cells. Then the general RTM process is conducted and the honeycomb products are finished. The cells with resins filled in are less than 1%. Flatwise tension and three-point bending tests are carried out to verify the bonding between the film and honeycomb core. This honeycomb core sealing can be done in less than forty minutes and the whole RTM process can be much faster than the existing methods.

### FIELD OF THE INVENTION

The present invention relates to a novel sealing process of honeycomb core which then can be used for the resin transfer molding (RTM) of honeycomb structures. Two thermoplastic polyurethane(TPU) films are heated and adhered on the surface of honeycomb core so as to prevent the resin from entering the core during process of resin transfer molding.

### BACKGROUND OF THE INVENTION

A honeycomb structure is used for decreasing the weight for airplanes or even the aeronautical flying objects because the specific structure bears much larger load with light weight when compared with other conventional structures used for those flaying objects. Composite material is further used to combine with the honeycomb structure such that the light-weight structure can be connected with each other to form the desired shape or even complex structure. U.S. Pat. No. 5,567,499 discloses a technique that, referring to FIGS. 1 and 2, seals the two surfaces of the honeycomb core 10 by a layer of cured adhesive film 12 and a layer of cured prepreg material 13 is connected to a top of the layer of adhesive film 12. Although it successfully seals the honeycomb core 10 such that resin cannot enter the interior of the honeycomb core 11, when processing Resin Transfer Molding, and a layer of fiber 14 can be connected to the layer of the prepreg material 13. It is time-consuming process to wait the adhesive film cure for sealing the honeycomb core and this prolongs the period of time of manufacturing. U.S. Pat. No. 5,569,508 discloses that foam material is filled in the honeycomb core so that no adhesive film is needed to seal the surfaces of the honeycomb core. This method involves complicated processes and a high cost.

The present invention intends to provide a honeycomb core and a method that seals the surface of the core by thermoplastic polyurethane films without the use of the layer of adhesive films.

### SUMMARY OF THE INVENTION

The present invention relates to method for sealing a honeycomb core and the method comprises step 1 of placing thermoplastic polyurethane (TPU) films onto the honeycomb core; step 2 of heating the TPU films up to the softening temperature of the TPU films; step 3 of pressing the TPU films to adhere the TPU films to the honeycomb core; and step 4 of cooling he combination of the thermoplastic polyurethane TPU films and the honeycomb core.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the honeycomb core assembly disclosed in U.S. Pat. No. 5,567,499;

FIG. 2 is a perspective view to show the honeycomb core assembly disclosed in U.S. Pat. No. 5,567,499;

FIG. 3 is an exploded view to show the honeycomb core assembly of the present invention;

FIG. 3A is an exploded view to show the honeycomb core assembly of the present invention and two layers of glass fiber tissues;

FIG. 4 is a perspective view to show the honeycomb core assembly of the present invention;

FIG. 5 is a cross sectional view to show the honeycomb core assembly of the present invention;

FIG. 6 is a diagram showing the relationship of the viscosity and temperature of the thermoplastic polyurethane (TPU) film;

FIG. 7 is an exploded view to show another embodiment of the honeycomb core assembly of the present invention;

FIG. 8 is a perspective view to show the honeycomb core assembly of the present invention as shown in FIG. 7;

FIG. 9 is a cross sectional view to show the honeycomb core assembly of the present invention as shown in FIG. 7; and

FIG. 10 shows the arrangement for processing Resin Transfer Molding to the honeycomb core assembly of the present invention.

FIG. 11 illustrates the curved honeycomb core sandwich panel sealed with TPU film and processed with fiberglass laminate facing.

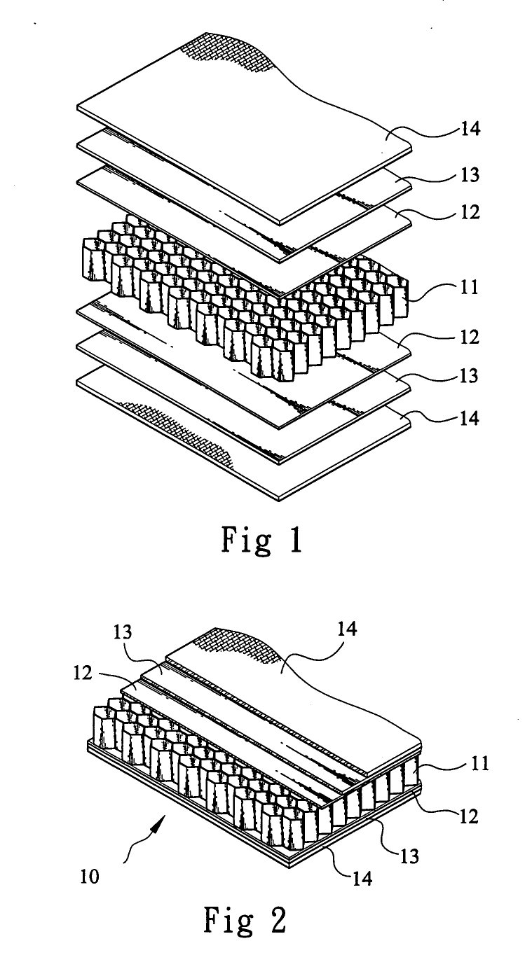

Table 1. Bonding strength of TPU film sealing for honeycomb core.

Table 2. Bending and shear strength of RTM specimens with different sealing methods.

### DETAILED DESCRIPTION OF THE PREFERRED EMBODIMENT

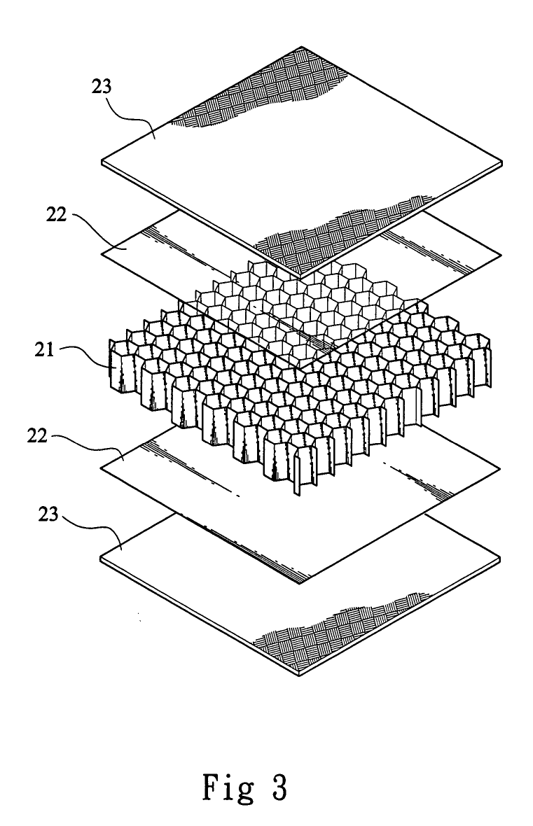

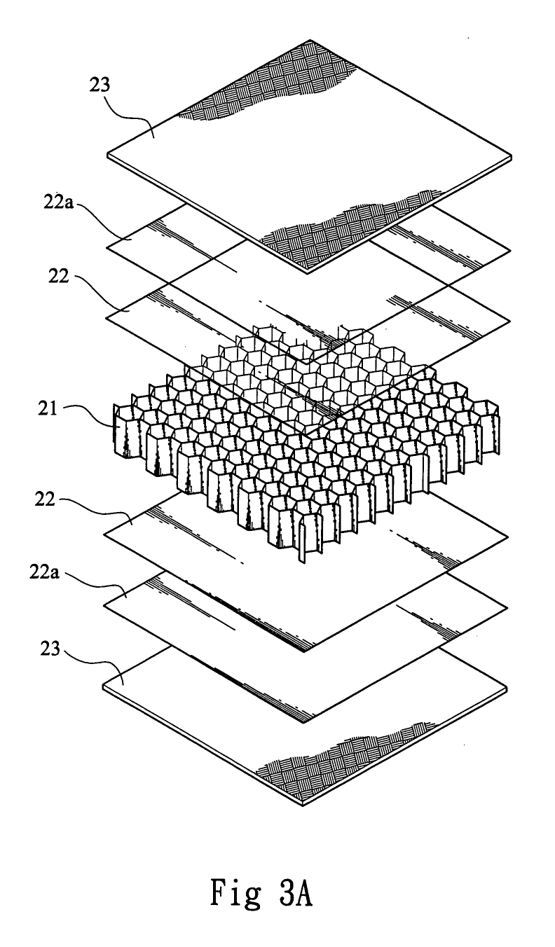

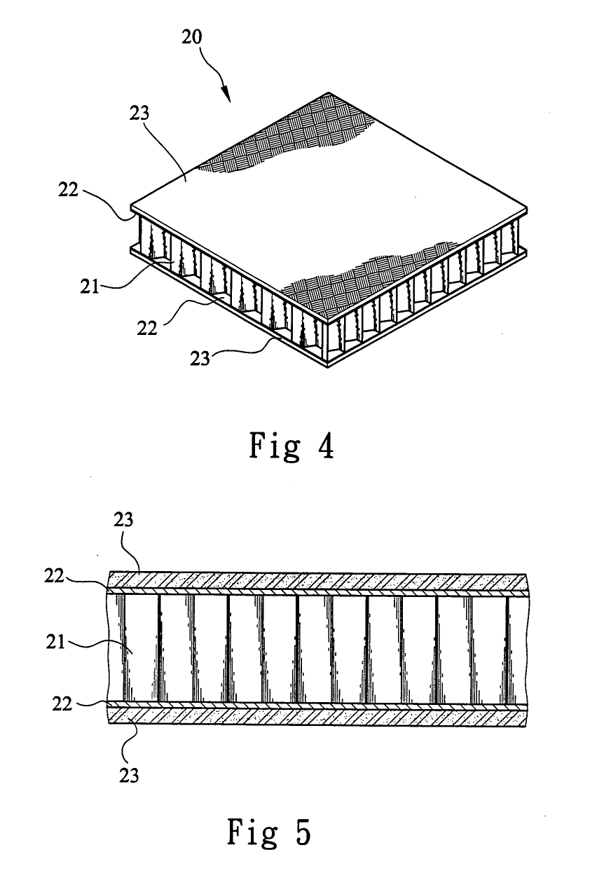

Referring to FIGS. 3 to 5, the method for sealing a honeycomb core of the present invention comprises the following steps:
step 1: placing thermoplastic polyurethane (TPU) films 22 onto the both the upper and the lower sides of honeycomb core 21;
step 2: heating the TPU films 22 up to the softening temperature of the TPU films 22;
step 3: pressing the TPU films 22 so as to adhere the TPU films 22 to the honeycomb core 21, and
step 4: cooling the combination of the TPU films 22 and the honeycomb core 21 to be a honeycomb core assembly 20.

The honeycomb core 21 can be made of aluminum, artificial fiber (Nomex), paper, carbon fibers or glass fibers. The thermoplastic TPU film 22 is 0.1 mm to 2.0 mm in thickness.

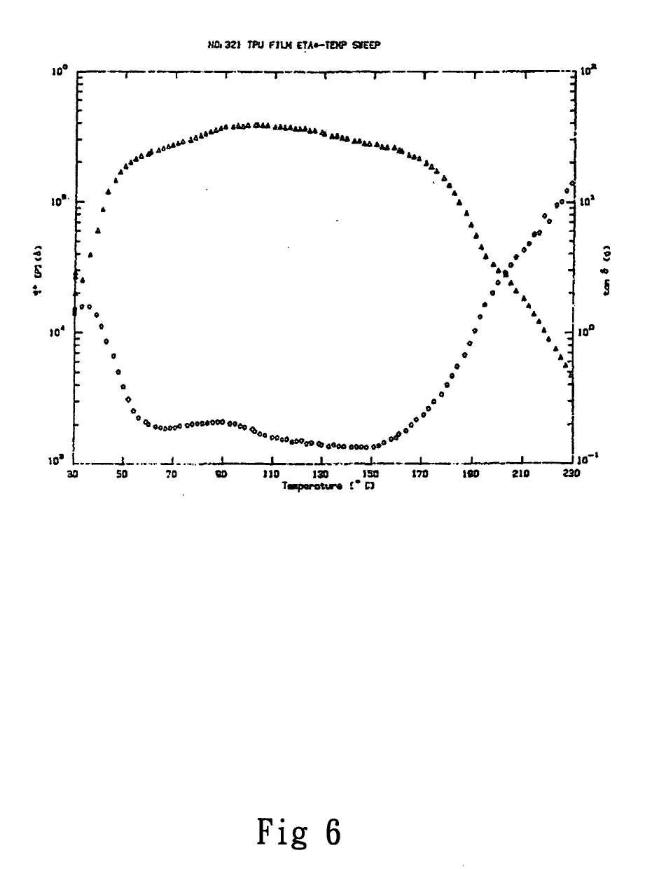

Referring to FIG. 6, the diagram showing the relationship of the viscosity and temperature of the TPU film 22 is made based on ASTM D4473 by Rheometrics Dynamic Spectrometer RMS-650. The viscosity descends gradually between 150 to 170 degrees Celsius and descends sharply from 190 degrees Celsius. Accordingly, the range between 150 to 170 degrees Celsius is chosen to be the heating range in step 2. The heating temperature in step 2 can also be in a range of 130 to 180 degrees Celsius for 1 to 60 minutes, or in a range of 140 to 170 degrees Celsius for 5 to 30 minutes.

Referring to FIG. 3A, a layer of glass fiber tissue 22a is adhered to the outside of each of the plastic films 22 so as to increase the ability of connection with other components.

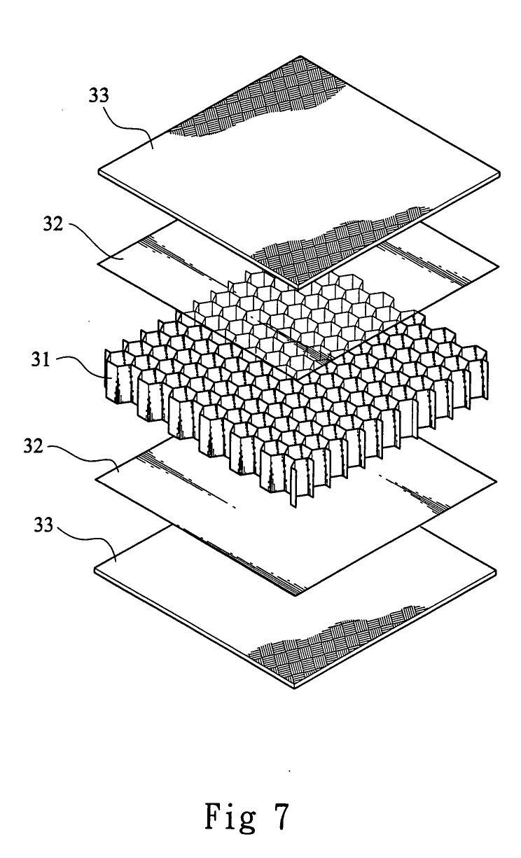

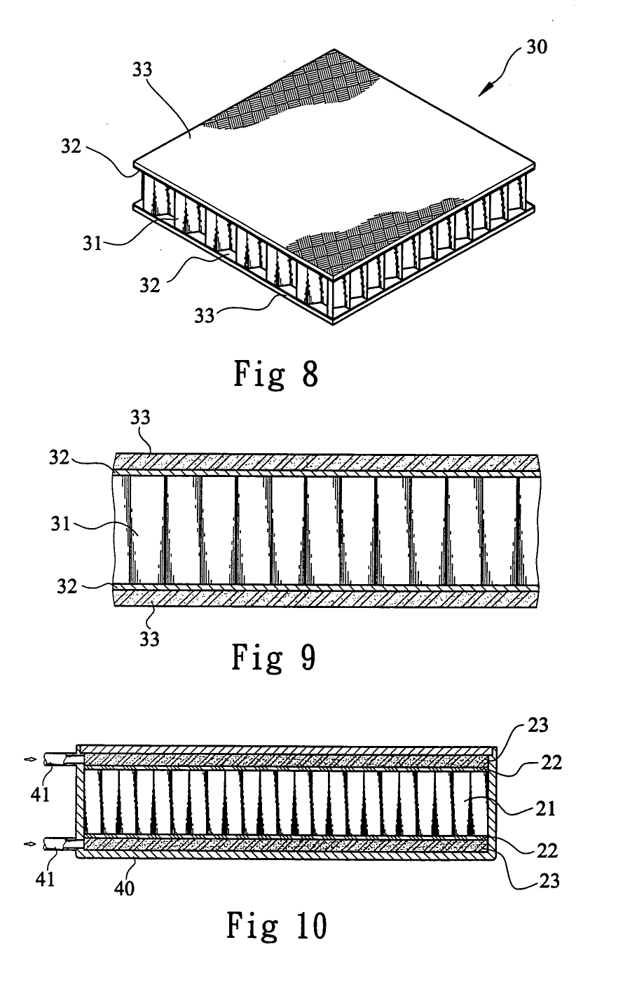

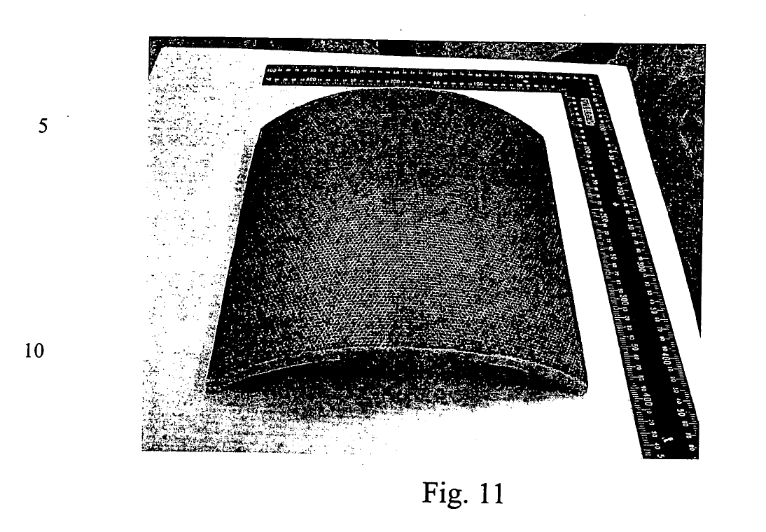

Referring to FIGS. 7 to 9, another embodiment of the method of the present invention to hand lay-up sealing of a honeycomb core 31 comprises the following steps:
step 1: soaking glass fiber fabric 32 with epoxy resin and making it partially cured for four hours and then placing the glass fiber fabric 32 onto two surfaces of the honeycomb core 31;
step 2: putting the combination of the honeycomb core 31 and the glass fiber fabric 32 with epoxy resin in a bag;
step 3: vacuuming the bag and the glass fiber fabric 32 being pressed by the atmosphere pressure of 0.08-0.1 MPa(12-14 psi) so as to seal the two surfaces of the honeycomb core 31, and
step 4: removing the bag from the combination of the honeycomb core 31 and the glass fiber fabric 32 with epoxy resin to have the glass fiber fabric sealed honeycomb core. After the sealing, the combination of honeycomb core 31 and the glass fiber fabric 32 can be conveniently connected to other components like the fiber perform 33 of surface panels to make the honeycomb core assembly 30.

The honeycomb core assembly 20 or 30 does not include the time-consuming cure of adhesive films as disclosed in U.S. Pat. No. 5,567,499 so that the sealing process of honeycomb core assembly 20 and 30 of the present invention can be as short as forty minutes and much faster than the existing methods which generally spend 2 hours or more.

FIG. 10 shows the arrangement for processing Resin Transfer Molding to the honeycomb core assembly of the present invention, wherein the TPU sealed honeycomb core combination of 21, 22 or combination of 21, 22, 22a or combination of 31 and 32 and glass fiber fabric sealed honeycomb core is put in the mold 40, and layers of performs 22 or 33 are added on the top and bottom of it. The resin is poured in the mold 40 from the inlet 41. Since the honeycomb core 21 or 31 is sealed so that the resin cannot enter the core 21 or 31 so that the weight balance can be controlled.

In order to make the preliminary check to see if the TPU film sealed under different heating conditions could provide adequate bonding strength with the honeycomb core, flatwise tension test is conducted on the sealed honeycomb core specimens of sealing method (A) and (D) without performing RTM process. Specimen (D) is used as the control test to be compared as reference. The sealed honeycomb cores are cut to the size of 2.5 cm×2.5 cm and bonded to the aluminum block with paste adhesive EA9359, then cured at room temperature for 24 hours. The flatwise tension test is performed per ASTM C297, on the MTS model 810, supplied by MTS corp. The crosshead speed is 3.8 mm/min.

The flatwise tension test results are shown in Table 1. The bonding strength between the sealing material and honeycomb core of carbon prepreg is 2.54 MPa, which could represent the standard level of conventional sealing performance of honeycomb core. Generally speaking, the bonding strength of TPU films is 1.31-1.72 MPa, which could be comparable to that of the control test. The specimens processed at higher temperature and longer time showed better results. Regarding the processing temperature is quite critical to the cost of processing, the 150° C./15 min condition is selected for the following RTM processes. On the other hand, the TPU film of 1.0 mm thick showed better bonding strength than the film of 0.4 mm thick. However, the difference is not great. Based on the lightweight consideration, the film of 0.4 mm is the preferred embodiment of this invention.

Concerning to the bending strength of facing laminate and the shear strength of interface, RTM specimens of four different sealing methods are made and cut to the size of 34.5 cm×2.5 cm and the three-point bending test is carried out per ASTM D790 on MTS Model 810, supplied by MTS Corp. The crosshead speed is 3.8 mm/min. The results of three-point bending test are shown in Table 2. There are three different kinds of failure mode for the bending test of honeycomb sandwich specimens, i.e. the bending failure of the facing laminate, the shear failure of the honeycomb, and the shear failure of the interface (the TPU film, the film adhesive, or the fiberglass tissue.) The specimens of sealing method D (with glass fiber fabric and hand lay-up) show the best results with the bending failure of the facing laminate. The bending strength is 1.69 MPa, and the shear strength of interface can be expected to be higher than 1.38 MPa. The specimens of all the other three sealing methods show shear failure of the sealing interface. The sealing method A and B (TPU film sealing) show shear strength of 0.64 MPa and 0.54 MPa, respectively. The sealing method D (with prepreg and film adhesive) shows the interface shear strength of 0.81 MPa, which can be deemed as the standard performance of the existing honeycomb sealing techniques for RTM process. The TPU sealing method results showed lower and comparable strength. It provides the advantage of a rapid process and can be finished within forty minutes, while the film adhesive curing usually needs more than 2 hours. Besides, the fiber glass tissue is not as expected to contribute improvement of the bonding between TPU film and the resin system of RTM process.

Concerning the sealing efficiency, the main challenge of the RTM process for structure with honeycomb core is the leakage of resin into the core cell. The lower the leakage is, the less the density of the honeycomb sandwich products will be. The honeycomb core of RTM specimens are separated from their carbon fiber composite facing laminate to count the percentage of leakage of the ratio of resin-filled cores versus the unfilled cores. The RTM specimen with prepreg/film adhesive sealing (sealing method C) existed leakage up to 2.5%, which confirms the data of EP Pat. 786,330 A2. On the other hand, the TPU sealing method can provide good barrier to prevent the resin entering the honeycomb core cells with the leakage as low as 0-0.5%. The low leakage proved that the TPU sealing could be a promising sealing method for RTM process of composite structures with honeycomb core.

The main challenge of the RTM process for structure with honeycomb core is the leakage of resin into the core cell. The lower the leakage is, the less the density of the honeycomb sandwich products will be. The honeycomb core of RTM specimens are separated from their carbon fiber composite facing laminate to count the percentage of leakage of the ratio of resin-filled cores versus the unfilled cores. The RTM specimen with prepreg/film adhesive sealing (sealing method C) existed leakage up to 2.5%, which confirms the data of EP Pat. 786,330 A2. On the other hand, the TPU sealing method can provide good barrier to prevent the resin entering the honeycomb core cells with the leakage as low as 0-0.5%. The low leakage proved that the TPU sealing could be a promising sealing method for RTM process of composite structures with honeycomb core.

After all, This invention has clearly show that the TPU sealing can be a good candidate for the RTM processing of structures with honeycomb cores. It can provides fair strength and a very good barrier for preventing resin leak into the core cells. The most attractive feature is the fast sealing process can be very economically efficient. In contrast, the sealing method of glass fiber fabric /hand lay-up is somewhat time-consuming, but it does not need heating and shows the best performance for RTM structures with honeycomb core, both in the bending behavior and the low leak of resin. Based on the stress level of design requirements for various sandwich structures, these two sealing methods can be beneficially applied in the RTM processes for aerospace community as well as industrial sectors.

While we have shown and described the embodiments in accordance with the present invention, it should be clear to those skilled in the art that further embodiments may be made without departing from the scope of the present invention.

TABLE 1
Bonding strength of TPU film sealing for honeycomb core.

| Specimen | | | Bonding Strength |
|---|---|---|---|
| Category | Sealing Material | Conditions | (MPa) |
| control | Carbon Prepreg + | 120° C./60 min | 2.54 |
| | Film Adhesive | | |
| 1 | TPU, 0.4 mm | 160° C./30 min | 1.52 |
| 2 | TPU, 0.4 mm | 160° C./15 min | 1.44 |
| 3 | TPU, 0.4 mm | 150° C./30 min | 1.08 |
| 4 | TPU, 0.4 mm | 150° C./15 min | 1.31 |
| 5 | TPU, 1.0 mm | 150° C./15 min | 1.72 |

TABLE 2
Bending and shear strength of RTM specimens
with different sealing methods.

| | | | | Shear | | |
|---|---|---|---|---|---|---|
| | | | | Strength | | |
| Seal- | | | | of | Leak | |
| ing | | | Bending | Inter- | of | |
| Meth- | | Condi- | Strength | face | Resin | |
| od | Material | tions | (MPa) | (MPa) | (%) | Remarks |
| A | TPU film, | 150° C./ | — | 0.64 | 0.5 | Shear |
| | 0.4 mm | vacuum/ | | | | failure |
| | | 15 min | | | | |
| B | TPU film, | 150° C./ | — | 0.54 | 0 | Shear |
| | 0.4 mm + | vacuum/ | | | | failure |
| | glass fiber | 15 min | | | | |
| | tissue | | | | | |
| C | carbon fiber | 121° C./ | — | 0.81 | 2.5 | Shear |
| | prepreg + | vacuum/ | | | | failure |
| | Film | 60 min | | | | |
| | adhesive | | | | | |
| D | fiberglass | Hand | 1.69 | >1.38 | 0.1 | Bending |
| | fabric + | Lay-up | | | | failure |
| | resin(Hand | RT/ | | | | |
| | lay-up) | vacuum/ | | | | |
| | | 24 h | | | | |

1-8. (canceled)

9. A honeycomb core assembly comprising:
a honeycomb core and two plastic films adhered onto two surfaces of the honeycomb core.

10. The honeycomb core assembly as claimed in claim 9, wherein the plastic film is a thermoplastic polyurethane (TPU) film.

11. The honeycomb core assembly as claimed in claim 9, wherein the honeycomb core is made of aluminum, artificial fiber (Nomex), paper, carbon fibers or glass fibers.

12. The honeycomb core assembly as claimed in claim 10, wherein the thermoplastic polyurethane (TPU) film is 0.1 mm to 2.0 mm in thickness.

13. The honeycomb core assembly as claimed in claim 9, wherein a layer of glass fiber tissue is adhered to an outside of each of the plastic films.

14. A honeycomb core assembly comprising:
a honeycomb core and two glass fiber fabric combined with epoxy resin being adhered onto two surfaces of the honeycomb core.

15. The honeycomb core assembly as claimed in claim 14, wherein the honeycomb core is made of aluminum, artificial fiber (Nomex), paper, carbon fibers or glass fibers.
